(19) United States
(12) Patent Application Publication
(10) Pub. No.: US 2024/0160338 A1
(43) Pub. Date: May 16, 2024

(54) METHOD, APPARATUS, TERMINAL AND STORAGE MEDIUM FOR DISPLAY CONTROL

(71) Applicant: Beijing Zitiao Network Technology Co., Ltd., Beijing (CN)

(72) Inventors: Zhaoyuan PENG, Beijing (CN); Zhaoyi LIU, Beijing (CN); Qianmin ZHANG, Beijing (CN); Jian SUN, Beijing (CN); Jie WEI, Beijing (CN)

(21) Appl. No.: 18/509,369

(22) Filed: Nov. 15, 2023

(30) Foreign Application Priority Data
Nov. 15, 2022 (CN) 202211429151.X

(51) Int. Cl. G06F 3/0483; G06F 3/04845; H04L 51/04

(52) U.S. Cl. CPC G06F 3/0483; G06F 3/04845; H04L 51/04

(57) ABSTRACT

A method, an apparatus, a terminal and a storage medium for display control is provided by the disclosure. The disclosure provides a method of display control which includes: displaying, in a display area of a target application, at least part of pages opened in the target application, if a number of pages opened in the target application exceeds n, displaying n opened pages in the display area of the target application and hiding other pages, and displaying a page identifier of a hidden page, n being not less than 1; and in response to a triggering operation on the page identifier, displaying a page corresponding to the triggered page identifier in the display area of the target application. The disclosure improves the efficiency of page jumping

### CROSS REFERENCE TO RELATED APPLICATIONS

The present application claims priority to Chinese Patent Application No. 202211429151.X, titled “Method, apparatus, terminal and storage medium for display control,” filed on Nov. 15, 2022, the contents of which are hereby incorporated by reference in their entirety.

### FIELD

The present disclosure relates to the field of computer technology, in particular

to a method, an apparatus, a terminal and a computer readable storage medium for display control.

### BACKGROUND

A communication client, such as an instant messaging client, by which people can have a session with friends and may receive messages sent by friends during the session. The received messages may include a hyperlink which may be triggered by clicking or other means to open the content of the hyperlink in a browser.

### SUMMARY

The present disclosure provides a method, an apparatus, a terminal and a storage medium for display control.

The present disclosure adopts the following technical solutions.

In some embodiments, the present disclosure provides a method of display control, comprising:
displaying, in a display area of a target application, at least part of pages opened in the target application, if a number of pages opened in the target application exceeds n, displaying n opened pages in the display area of the target application and hiding other pages, and displaying a page identifier of a hidden page, n being not less than 1; and
in response to a triggering operation on the page identifier, displaying a page corresponding to the triggered page identifier in the display area of the target application.

In some embodiments, the present disclosure provides an apparatus for display control, comprising:
a displaying module configured to display, in a display area of a target application, at least part of pages opened in the target application, if a number of pages opened in the target application exceeds n, display n opened pages in the display area of the target application and hide other pages, and display a page identifier of a hidden page, n being not less than 1;
a controlling module configured to, in response to a triggering operation on the page identifier, display a page corresponding to the triggered page identifier in the display area of the target application.

In some embodiments, the present disclosure provides a terminal, comprising: at least one memory and at least one processor,
wherein the memory is configured to store program code, and the processor is configured to call the program code stored in the memory to implement the method mentioned above.

In some embodiments, the present disclosure provides a computer readable storage medium, wherein the computer readable storage medium is configured to store program code, and the program code, when executed by a computer, causes the computer to implement any of the methods mentioned above.

The embodiments of the present disclosure provide a method of display control. If the number of pages opened in a target application is greater than n, only n pages are displayed in the display area, and other pages that are not displayed are automatically hidden. In addition, a page identifier of the hidden page is displayed in the target application, and users may operate on a corresponding page identifier, for example by clicking on or the like to return to the corresponding page, thereby improving the user efficiency of using the page, and enabling the hidden pages to be quickly returned to.

### BRIEF DESCRIPTION OF THE DRAWINGS

In combination with the accompanying drawings and with reference to the following detailed description, the above and other features, advantages, and aspects of the embodiments of the present disclosure will become more apparent. Throughout the drawings, the same or similar reference numerals denote the same or similar elements. It should be understood that the drawings are illustrative, and elements are not necessarily drawn to scale.

FIG. 1 is a flowchart of a method of display control according to the embodiments of the present disclosure.

FIG. 2 to FIG. 6 are schematic diagrams of display interfaces according to the embodiments of the present disclosure.

FIG. 7 is a schematic structural diagram of the electronic device according to the embodiments of the present disclosure.

### DETAILED DESCRIPTION

The embodiments of the present disclosure will be described in more detail below

with reference to the accompanying drawings. Although some embodiments of the present disclosure are shown in the drawings, it should be understood that the present disclosure can be implemented in various forms and should not be interpreted as limited to the embodiments described herein. On the contrary, these embodiments are provided for a more thorough and complete understanding of the present disclosure. It should be understood that the accompanying drawings and embodiments of the present disclosure are only for illustrative purposes and are not intended to limit the scope of protection of this disclosure.

It should be understood that various steps recorded in the disclosed method implementation may be executed in different orders and/or in parallel. In addition, the method implementation may include additional steps and/or omit the steps shown for execution. The scope of this disclosure is not limited in this regard.

The term “including” and its variations used herein are open inclusion, that is, “including but not limited to”. The term “based on” refers to “at least partially based on”. The term “one embodiment” means “at least one embodiment”; The term “another embodiment” means “at least one other embodiment”; The term “some embodiments” means “at least some embodiments”. The relevant definitions of other terms will be given in the following description.

It should be noted that the concepts such as “first” and “second” mentioned in this disclosure are only used to distinguish different apparatus, modules or units, and are not intended to limit the order or interdependence of the functions performed by these apparatus, modules or units.

It should be noted that the modifications of “one” and “multiple” mentioned in this disclosure are indicative rather than restrictive, and those skilled in the art should understand that unless otherwise explicitly stated in the context, they should be understood as “one or more”.

The names of the messages or information exchanged between apparatuses in embodiments of the present disclosure are for illustrative purposes only and are not intended to limit the scope of these messages or information.

The solution provided by the embodiments of the present application will be described in detail in combination with the accompanying drawings in the following.

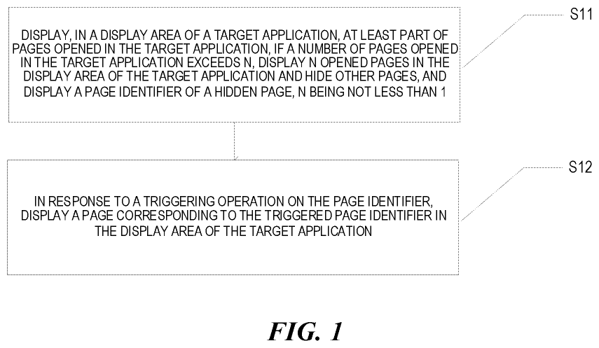

As shown in FIG. 1, FIG. 1 is a flowchart of a method of display control according to some embodiments of the present disclosure, which includes the following steps.

S11: display, in a display area of a target application, at least part of pages opened in the target application. If a number of pages opened in the target application exceeds n, display n opened pages in the display area of the target application and hide other pages, and display a page identifier of a hidden page. n is not less than 1.

In some embodiments, the target application may be a communication client, for example. The target application has a display area, and a page opened in the target application may be displayed in the display area by default. Pages displayed in the display area, for example, may be independent windows. The display area may display up to n windows at once. If the number of opened pages is not greater than n, all opened pages may be displayed in the display area, so that n opened pages may be seen at the same time. However, if the number of pages exceeds n, all pages cannot be displayed in the display area at once, then n pages may be displayed, for example, n pages that are recently opened may be displayed, and other pages that have not been displayed but have been opened may be hidden (that is, the pages are concealed). At the same time, a page identifier of the hidden page may be displayed in a form of floating identifier. The identifier may be text or a chart, for example, it may be displayed in the display area by default. The identifier may be displayed in a form of dock to hover. The style of the page identifier may be related to the type of the corresponding page, for example, an identifier of a page which is a type of document may be a symbol of book, and an identifier of a session page may be a symbol of message. In some embodiments, as long as there is a hidden page, the page identifier is always displayed in the target application and may not disappear due to changes in the page displayed in the display area. In some embodiments, at least part of windows in the pages currently displayed in the display area may not have a corresponding page identifier, while the hidden page may have a corresponding page identifier. For example, if n is greater than 1, the page located in a predetermined location in the display area (the predetermined location may be a location of the page corresponding to the triggered page identifier displayed by default if the page identifier is triggered, for example, may be a location closest to a first side in the display area for displaying the page) may not have a corresponding page identifier, while the hidden page and other pages in the display area may have corresponding page identifiers.

S12: in response to a triggering operation on the page identifier, display a page corresponding to the triggered page identifier in the display area of the target application.

In some embodiments, the page identifier may be triggered by means such as clicking. After the page identifier is triggered, the page corresponding to the page identifier will be displayed in the display area. Because the page corresponding to the page identifier has been opened, the triggered page identifier will disappear. In some embodiments, because the display area may display up to n pages at the same time, one of the pages displayed before the page identifier is triggered may be hidden or closed after the page identifier is triggered. In some embodiments, the page displayed in the display area before the triggering operation may be hidden. In some further embodiments, the page whose opening time is earlier than it of the page corresponding to the triggered page identifier will be closed after the triggering operation. In some embodiments, if n is equal to 1, only the page corresponding to the triggered page identifier is displayed. If n is greater than 1, in addition to the page corresponding to the triggered page identifier, the page corresponding to the page identifier whose opening time is earlier or later than the triggered page identifier may be further displayed in the display area. In some embodiments, the pages opened in the target application are arranged continuously, that is, respective pages are sorted in order. If n is greater than 1, after the triggering operation is performed, the page corresponding to the triggered page identifier and n-1 adjacent pages are displayed in the display area of the target application. The n-1 pages may be a first side or a second side of the page corresponding to the triggered page identifier. For example, if the newly opened page is automatically displayed on the right side of the existing page, that is, the pages are arranged from left to right (certainly, they may further be arranged from right to left or from top to bottom), and n is 2, then after the triggering operation is performed, the page corresponding to the triggered page identifier and a page located on the left or right side of the page are displayed in the display area of the target application. If n is equal to 3, the page corresponding to the triggered page identifier and two pages located on the left side, two pages located on the right side, or one page on the left side and one page on the right side of the page may be displayed in the display area of the target application after the triggering operation is performed.

In some embodiments of the present disclosure, if the number of pages is greater than n, the pages may be automatically hidden by the target application, and page identifiers of the hidden pages are displayed in the target application in a form of navigation. A corresponding page may be returned to by clicking on its corresponding page identifier, thereby improving the user efficiency of using the page and enabling the hidden pages to be quickly returned to without having to step back or close the pages one by one.

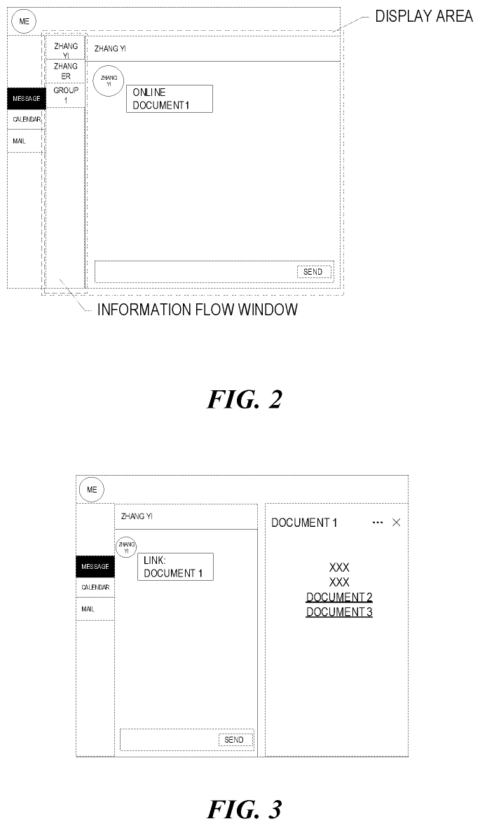

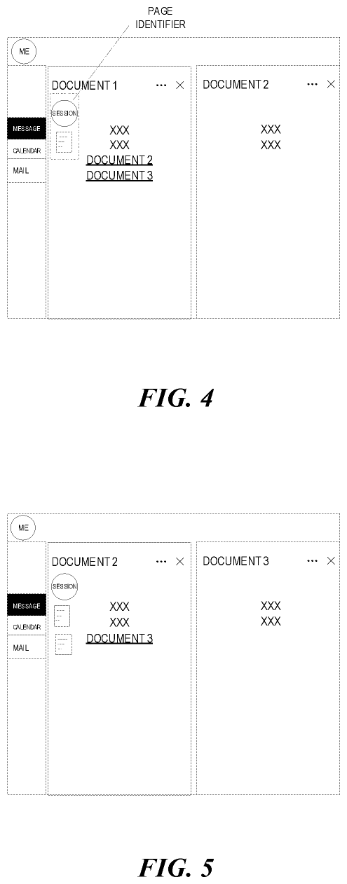

In order to illustrate the method proposed in the embodiment of the present disclosure in a better way, the following will be described in combination with FIG. 2 to FIG. 4. Taking the target application as a communication client as an example, if a user clicks on a link such as a document in the target application, a new page is opened in the target application instead of jumping to the browser, which is displayed side by side with the current page. As shown in FIG. 2, a page with a session (with Zhang Yi) is displayed in the communication client, and a link of Document 1 is sent by Zhang Yi. By triggering the link of Document 1, as shown in FIG. 3, a new page is opened in the display area to display Document 1. Document 1 includes links of Document 2 and document 3. By triggering the link of Document 2, as shown in FIG. 4, a new page is opened in the display area to display the page of Document 2, and n is 2 in the target application. Therefore, the session window is hidden, and as shown in FIG. 4, the identifier of the session window and the identifier of Document 1 is displayed. In this embodiment, except for the page located at a predetermined location of the display area (the rightmost side of the display area in FIG. 4), other pages may have corresponding page identifiers. By clicking on the page identifier of the session, the display area shown in FIG. 2, that is, the page displaying the session, will be displayed.

If the page identifier of Document 1 is clicked on, the display area shown in FIG. 3 will be displayed. In this embodiment, after the page identifier is triggered, the corresponding page will be displayed at the predetermined location in the display area.

In some embodiments of the present disclosure, the n opened pages displayed in the display area are horizontally arranged for display; the page identifier of the hidden page is vertically arranged on a left sidebar side or a right sidebar side of the display area.

In some embodiments, as shown in FIG. 2, it is a schematic diagram of a page displaying a session window in the target application. In FIG. 3, an additional page of Document 1 is opened on the basis of FIG. 2. In FIG. 4, a further page of Document 2 is opened on the basis of FIG. 3, and n is 2. Therefore, the session window is hidden, and the page identifier of the session window is displayed at the same time. If an additional page of document 3 is opened on the basis of FIG. 4, the page of Document 1 is also hidden, and the session window and the page identifier of Document 1 are displayed. As shown in FIG. 2 to FIG. 5, the pages displayed in the display area are horizontally arranged for display, and the newly opened pages may be displayed on the right side of the opened pages. The page identifier is vertically displayed on the left sidebar side or the right sidebar side of the display area at the same time, thereby avoiding the content of the page being blocked by the page identifier. The page identifier may be displayed in a semi-transparent form to further avoid blocking the content of the page.

In some embodiments of the present disclosure, the target application is an instant messaging application; or, the target application is an application suite that integrates an instant messaging application and at least one further application. In some embodiments, the page opened in the target application may be a session page, a document page, a video page, or the like, and a display container may be integrated into the instant messaging application to display different types of pages. The application suite may be an application suite that integrates an instant messaging application, a document application, a video application, so that a document page, a video page, or the like may be opened in the suite application, instead of jumping to the browser to open different types of pages. In this embodiment, the application scenario of the method may be a working scenario, where users directly open different types of pages in an instant messaging application or an application suite instead of jumping to the browser, so that users may avoid complicated operations on jumping between different applications, which is in line with user habits.

In some embodiments of the present disclosure, the pages opened in the target application include a session window, or a session window of a first session and a further window. The first session is a currently ongoing session. In some embodiments, the further window is a window opened directly or indirectly based on the session window of the first session. In some embodiments, the page opened in the target application is related to a session, and the page opened directly or indirectly based on the session window of the first session may refer to a session window of a node located in the first session in the triggering path. For example, if a page is opened by triggering a link in the session window of the first session, the page is opened directly based on the session window of the first session. If a page is opened by triggering the first link in the first session so that the first page is opened, and then triggering the second link in the first page, then the triggering path of the page is from the first link to the second link. Because the first link is located in the session window of the first session, the page is opened indirectly based on the session window of the first session. Certainly, the triggering path may be a link that triggers more links. In this embodiment, the pages opened by the target application may be the session window of the first session and the further page opened based on the session window of the first session, which have an association relationship. Therefore, a co-display of the associated pages may be realized, which is convenient for users to trace back.

In some embodiments of the present disclosure, the method further comprises: in response to switching to a second session, closing the session window of the first session and the further page that are opened before switching to the second session. In some embodiments, the first session is the session originally opened in the target application, and the session that can be opened at one time in the target application may be one. When the first session is switched to the second session, the session window of the second session will be displayed, and the session window of the first session and other pages opened based on the first session may be closed at this time. As shown in FIG. 3, the first session is displayed in the communication client, and there may be a link in the session window of the first session. The further page may be opened by triggering the link, and there may be a link in the opened further page. Another further page may be opened by triggering the link in the opened further page. The session window is equivalent to a root node of the further page, which is directly or indirectly extended by the session window. Therefore, the further page relies on the first session. When the currently ongoing session is switched, and if the session window of the second session is opened, the session window of the first session will be closes and the further window will be closed together, so that users do not have to close pages manually.

In some embodiments of the present disclosure, n is not less than 2, and the communication client includes an information flow window located in the display area. If n pages are displayed in a display area of the communication client, the information flow window is hidden; if the number of pages displayed in the display area of the communication client is less than n, the information flow window is displayed. In some embodiments, the information flow window does not belong to the page opened by the target application. As shown in FIG. 3, the information flow window is displayed in the display area of the target application (the vertical column where “Zhang Yi, Zhang Er, Group 1” is located in FIG. 3 usually is a session list). If the number of pages displayed in the display area is small, as shown in FIG. 3, the information flow window may be displayed. As shown in FIG. 4, if n pages are displayed in the display area (n is 2 in FIG. 4), the information flow window is no longer displayed in order to display the page in a better way, which increases the area of the page displayed in the display area. In some embodiments, the identifier corresponding to the information flow window is not displayed after it is hidden.

In some embodiments of the present disclosure, displaying, in a display area of a target application, at least part of pages opened in the target application comprises: displaying a session window in the display area, in response to an operation on a link element in the session window, opening a target page referenced by the link element in a page container at a same level as the session window.

In some embodiments, as shown in FIG. 2, a session window is displayed in the target application. If there is a link referenced by a link element in the session window, the target page referenced by the link element may be opened by operating on the link element (for example, clicking on the link element). At the same time, the opened target page is not displayed in the session window, while in a page container at the same level as the session window. By presenting the opened page with the page container, the occupation of the target page on the session window is released, and users may view the target page and the session window at the same time, which is convenient for users to use.

In some embodiments of the present disclosure, displaying, in a display area of a target application, at least part of pages opened in the target application comprises: displaying, in the display area, an information flow window and a session window; and in response to an operation on a link element in the session window, opening a target page referenced by the link element in a page container at a same level as the session window, displaying the session window and the target page referenced by the link element in the display area, and hiding the information flow window.

In some embodiments, as shown in FIG. 2, if only the information flow window and the session window are displayed in the display area, the information flow window may not be hidden. If the link element is triggered, the session window and the target page referenced by the link element will be displayed in the display area. At this time, the information flow window is hidden in order to display the session window and the target page as much as possible, thereby expanding the area for displaying the session window and the target page.

In some embodiments of the present disclosure, in response to an operation on a link element in the session window, opening a target page referenced by the link element in a page container at a same level as the session window comprises: in response to an operation on the link element in the session window, intercepting an event of opening the target page; deciding whether the target page meets a condition of opening in the page container; if the condition is satisfied, adding a new page container and opening the target page in the newly added page container; if the condition is unsatisfied, opening the target page in a browser.

In some embodiments, after the link element is operated on, an event of opening the target page in the browser is usually generated. In this embodiment, the event is intercepted so that the target page is not immediately opened in the browser. At this time, whether the condition of opening in the page container is met may be decided. For example, the condition may be that the number of pages opened by the target application does not exceed m. If this condition is met, the target page may be opened in the page container of the target application without opening the target page in the browser. If this condition is not met, the target page will be opened in the browser. In some embodiments of the present disclosure, the page container is a container implemented by an inline frame element. For example, the inline frame element may be an iframe element, and the page container is realized by using the inline frame element without opening the target page in the browser.

In some embodiments of the present disclosure, if n pages are displayed in the display area, in response to opening a new page in the target application, n pages comprising the new page are displayed in the display area, one of the n pages displayed before opening the new page is hidden, and a page identifier corresponding to the hidden page is displayed.

In some embodiments, in case where n pages have already been displayed in the display area, if a new page is opened at this time, n pages including the new page may be displayed, and one page needs to be hidden. The hidden page may be, for example, the earliest opened page among the n pages displayed before the new page is opened. A corresponding page identifier of the page may be displayed after the page is hidden.

In some embodiments of the present disclosure, a newly opened page in the target application locates on a first side of an opened page. In some embodiments, the pages may be sorted from left to right, and the first side may be the right side. Each time a new page is opened, it will be displayed on the right side of the existing page, thus achieving continuous sorting of the pages.

In some embodiments of the present disclosure, if a second new page is opened by performing an operation on a first opened page, the second page is displayed at a location adjacent to a first side of the first page on which the operation is performed. In some embodiments, the newly opened second page is always on the first side of the operated first page, and the locations of the two pages are adjacent, which is because the newly opened second page is opened because of the first page, and the two pages have an association relationship. The two pages are displayed adjacent to each other to facilitate users to view the first page and the second page together. In some embodiments, performing an operation on the first page may be triggering a link on the first page, for example.

In some embodiments of the present disclosure, n is not less than 2, and if the second new page is opened by performing an operation on the first opened page, the first page and the second page are displayed in the display area. In some embodiments, if the second page is opened by performing an operation on the first page, the first page and the second page are simultaneously displayed in the display area to ensure that users can view them simultaneously and facilitate comparison.

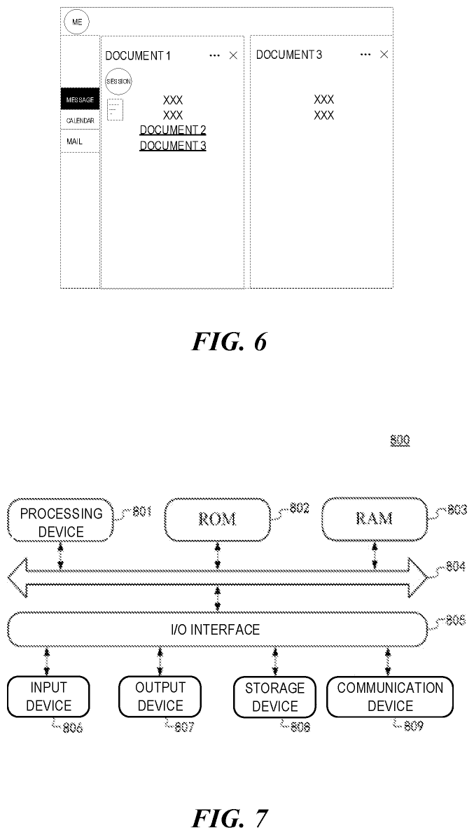

In some embodiments of the present disclosure, n is not less than 2, before performing an operation on the first opened page, n pages are displayed in the display area; if the first page is not a page closest to a first side in the display area, the page closest to the first side in the display area is closed while opening the second page, and if the first page is the page closest to the first side in the display area, a page closest to a second side in the display area is hidden. The second side and the first side are two opposite sides. In some embodiments, the pages in the target application are sorted in order, and the newly opened page is located on the first side of the previous page. If the first page and the third page are displayed in the display area before the operation is performed, and the third page is located closest to the first side of the display area, after the second page is opened, the third page may be closed because the sorting is disrupted as the second page is adjacent to the first page. This ensures the rationalization of the sorting. As shown in FIG. 4, the first side is the right side on the horizontal, and the second side is the left side on the horizontal. The page that triggers Document 1 is the first page. The link of “Document 3” is displayed in Document 1. As shown in FIG. 6, the page of Document 3 is displayed on the right side of Document 1 and the page of Document 2 is closed. If the first page is located closest to the first side in the display area before the second page is opened, the page closest to the second side in the display area may be hidden. For example, the page of Document 1 in FIG. 3 is the first page, which is located closest to the first side (right side) in the display area. At this time, the link of Document 2 in Document 1 is triggered. As shown in FIG. 4, the page of Document 2 is displayed on the right side of Document 1, and the session window originally located on the left side of the display area is hidden.

In some embodiments of the present disclosure, a newly opened page in the target application is displayed on a first side of an opened page, upon the page identifier being triggered, a page located on the first side of a page corresponding to the triggered page identifier is closed. In some embodiments, the newly opened page in the target application is arranged on the first side of the opened page. For example, the first side is the right side on the horizontal. At this time, the opened pages in the target application are horizontally arranged, and a page flow is formed. Each page has a location in the page flow. Upon the page corresponding to the triggered page identifier being opened, the opened page is located closest to the location on the first side of the display area. The page located on the first side of the opened page in the page flow will be automatically closed, and there will be no more opened pages. In this way, the effect of batch closing pages is achieved by jumping to the opened page, without the need for users to close the page manually.

In some embodiments of the present disclosure, in response to a page displayed in the display area moving out of the display area in a direction towards the first side of the display area, the page moved outside the display area is closed. In some embodiments, the first side may be a horizontal right side, and the second side may be a horizontal left side.

The page which is moved to the right side of the displayed page in the display area is automatically closed, and the page which is moved to the left side of the displayed page in the display area is automatically hidden, so that the page may be closed by a simple sliding operation. The page may be closed by sliding the displayed page to the first side.

In some embodiments of the present disclosure, in response to closing a page currently displayed in the display area, a page from the hidden pages that is adjacent to a location of the currently displayed page is displayed. In some embodiments, as shown in FIG. 4, the pages displayed in the display area are pages of Document 1 and Document 2. If one of the pages or both pages are closed, the page adjacent to Document 1 and Document 2 will be opened from the hidden pages for displaying in the display area. For example, if Document 2 is closed, the display area shown in FIG. 3 will be displayed.

In some embodiments of the present disclosure, in response to a number of pages opened in the target application reaches m, a newly opened page is opened by a browser. m is greater than n. In some embodiments, the upper limit of the pages that can be opened may be set, for example, m may be set to 10. If the number of pages opened in the target application exceeds 10, the pages are opened through a browser instead of the target application which is not a browser.

In some embodiments of the present disclosure, the page has a first control for opening the page in a browser. In some embodiments, the content displayed on the page may be the content of a webpage, such as an online document, and can therefore be viewed through a browser. In some embodiments, the page has a second control for closing the page.

In some embodiments of the present disclosure, in response to the opened page being a document page, at least one of document notification, comment area, or directory area is hidden by default. In some embodiments, the document page, for example, is a page that displays an online document. Because the display area of the target application is limited by the area for display, the document notification, the comment area, the directory area are hidden to avoid obscuring the document content. An entrance to the document notification, the comment area, the directory area may be retained in the document page, and the document notification, the comment area, the directory area may be accessed through the entrance.

In some embodiments of the present disclosure, in response to a control identifier hovering over the page identifier, page information of a page corresponding to the page identifier is displayed. In some embodiments, the page information may include, for example, the page name, the thumbnail of the page, or the like, and the control identifier may be a mouse, or the like. By displaying the page information, users may know the page corresponding to the page identifier.

In some embodiments of the present disclosure, in response to a moving operation on the page identifier, a display location of the page identifier is adjusted. In some embodiments, the page identifier is non-fixed and may be suspended in the display area, and the display location of the page identifier may be changed by dragging the page identifier.

In some embodiments of the present disclosure, an apparatus for display control is proposed. The apparatus comprises:
a displaying module configured to display, in a display area of a target application, at least part of pages opened in the target application, if a number of pages opened in the target application exceeds n, display n opened pages in the display area of the target application and hide other pages, and display a page identifier of a hidden page, n being not less than 1; and
a controlling module configured to, in response to a triggering operation on the page identifier, display a page corresponding to the triggered page identifier in the display area of the target application.

In some embodiments, the n opened pages displayed in the display area are horizontally arranged for display; the page identifier of the hidden page is vertically arranged on a left sidebar side or a right sidebar side of the display area.

In some embodiments, the target application is an instant messaging application; or, the target application is an application suite that integrates an instant messaging application and at least one further application.

In some embodiments, the pages opened in the target application comprises a session window.

In some embodiments, the pages opened in the target application comprise a session window of a first session and a further page; the further page is a page opened directly or indirectly based on the session window of the first session.

In some embodiments, the controlling module is further configured to: in response to switching from the first session to a second session, close the session window of the first session and the further page that are opened before switching to the second session.

In some embodiments, n is not less than 2, and the target application has an information flow window located in the display area; if n pages are displayed in a display area of a communication client, the information flow window is hidden; if a number of pages displayed in the display area is less than n, the information flow window is displayed.

In some embodiments, displaying, in a display area of a target application, at least part of pages opened in the target application comprises displaying a session window in the display area, in response to an operation on a link element in the session window, opening a target page referenced by the link element in a page container at a same level as the session window.

In some embodiments, displaying, in a display area of a target application, at least part of pages opened in the target application comprises: displaying, in the display area, an information flow window and a session window; and in response to an operation on a link element in the session window, opening a target page referenced by the link element in a page container at a same level as the session window, displaying the session window and the target page referenced by the link element in the display area, and hiding the information flow window.

In some embodiments, in response to an operation on a link element in the session window, opening a target page referenced by the link element in a page container at a same level as the session window comprises:
in response to an operation on the link element in the session window, intercepting an event of opening the target page;
deciding whether the target page meets a condition of opening in the page container;
if the condition is satisfied, adding a new page container and opening the target page in the newly added page container;
if the condition is unsatisfied, opening the target page in a browser.

In some embodiments, the page container is a container implemented by an inline frame element.

In some embodiments, if n pages are displayed in the display area, the displaying module is further configured to, in response to opening a new page in the target application, display n pages comprising the new page in the display area, hide one of the n pages displayed before opening the new page, and display a page identifier corresponding to the hidden page.

In some embodiments, at least one of the following is satisfied:
a newly opened page in the target application locates on a first side of an opened page;
if a second new page is opened by performing an operation on a first opened page, the second page is displayed at a location adjacent to a first side of the first page on which the operation is performed.

In some embodiments, n is not less than 2, and if the second new page is opened by performing an operation on the first opened page, displaying the first page and the second page in the display area; and/or
n is not less than 2, before performing an operation on the first opened page, n pages are displayed in the display area; if the first page is not a page closest to a first side in the display area, closing the page closest to the first side in the display area while opening the second page, and if the first page is the page closest to the first side in the display area, hiding a page closest to a second side in the display area, the second side and the first side being two opposite sides.

In some embodiments, a newly opened page in the target application is displayed on a first side of an opened page, upon the page identifier being triggered, a page located on the first side of a page corresponding to the triggered page identifier is closed.

In some embodiments, the controlling module is further configured to: in response to a page displayed in the display area moving out of the display area in a direction towards the first side of the display area, close the page moved outside the display area.

In some embodiments, the displaying module is further configured to, in response to closing a page currently displayed in the display area, display a page from the hidden pages that is adjacent to a location of the currently displayed page.

In some embodiments, in response to a number of pages opened in the target application reaches m, a newly opened page is opened by a browser. m is greater than n.

In some embodiments, the page has a first control for opening the page in a browser.

In some embodiments, in response to the opened page being a document page, at least one of document notification, comment area, or directory area by default is hidden.

In some embodiments, the displaying module is further configured to, in response to a control identifier hovering over the page identifier, page information of a page corresponding to the page identifier is displayed.

In some embodiments, the displaying module is further configured to, in response to a moving operation on the page identifier, a display location of the page identifier is adjusted.

For the embodiments of the apparatus, because it basically corresponds to the method embodiments, the relevant parts can be referred to the description of the method embodiments part. The apparatus embodiments described above are only illustrative, and the module described as a separate module may be separate or may not be separate. Some or all of the modules can be selected according to actual needs to achieve the purpose of the embodiments of the present disclosure. Those skilled in the art can understand and implement the embodiments without creative labor.

The method and apparatus of the present disclosure have been described above based on embodiments and implementations. In addition, the present disclosure further provides a terminal and a storage medium, which are described below.

Reference is made to FIG. 7, which is a schematic structural diagram illustrating an electronic device (for example, a terminal device or a server) 800 suitable for implementing the embodiments of the present disclosure. The terminal device in the embodiments of the present disclosure may include but is not limited to a mobile terminal such as a mobile phone, a notebook computer, a digital broadcast receiver, a PDA (personal digital assistant), a PAD (tablet), a PMP (portable multimedia player), and an in-vehicle terminal (e.g., in-vehicle navigation terminal) as well as a stationary terminal such as a digital TV and a desktop computer. The electronic device shown in the figure is only an example and should not impose any limitation on the function and scope of use of the embodiments of the present disclosure.

As shown in FIG. 7, the electronic device 800 may include a processing device (for example, a central processing unit, or a graphics processing unit) 801. The processing device 801 may perform various appropriate actions and processing according to a program stored in a read only memory (ROM) 802 or a program loaded from a storage device 808 into a random-access memory (RAM) 803. In the RAM 803, various programs and data necessary for the operation of the electronic device 800 are also stored. The processing device 801, the ROM 802, and the RAM 803 are connected to each other via a bus 804. An input/output (I/O) interface 805 is also connected to the bus 804.

Generally, the following apparatuses may be connected to the I/O interface 805: an input device 806 including, for example, a touch screen, a touch pad, a keyboard, a mouse, a camera, a microphone, an accelerometer and a gyroscope; an output device 807 including, for example, a liquid crystal display (LCD), a speaker and a vibrator; a storage device 808 including, for example, a tape and a hard disk; and a communication device 809. The communication device 809 may allow the electronic device 800 to communicate wirelessly or by wire with other devices so as to exchange data. Although the figure shows the electronic device 800 having various apparatuses, it should be understood that the electronic device 800 is unnecessary to implement or have all of the illustrated apparatuses. Alternatively, the electronic device 800 may implement or be equipped with more or fewer apparatuses.

Particularly, according to embodiments of the present disclosure, the processes described above with reference to the flowcharts may be implemented as computer software programs. For example, a computer program product is provided according to embodiments according to the present disclosure. The computer program product includes a computer program carried on a computer readable medium. The computer program contains program code for carrying out the method shown in the flowchart. In such embodiments, the computer program may be downloaded and installed from the network via the communication device 809 or installed from the storage device 808 or the ROM 802. When the computer program is executed by the processing device 801, the functions defined in the method of the embodiments of the present disclosure are implemented.

It should be noted that the computer readable medium described in the present disclosure may be a computer readable signal medium or a computer readable storage medium, or any combination of the above two. The computer readable storage medium may include but is not limited to electrical, magnetic, optical, electromagnetic, infrared, or semiconductor systems, apparatuses, or devices, or a combination of any of the above, for example. More detailed examples of the computer readable storage medium may include but are not limited to an electrical connection with one or more wires, a portable computer disk, a hard disk, a random-access memory (RAM), a read only memory (ROM), an erasable programmable read only memory (EPROM or a flash memory), an optical fiber, a portable compact disk read only memory (CD-ROM), an optical storage device, a magnetic storage device, or any suitable combination of the above. In the present disclosure, the computer readable storage medium may be any tangible medium that contains or stores a program. The program may be used by or in conjunction with an instruction execution system, apparatus or device. In the present disclosure, however, the computer readable signal medium may include a data signal broadcasted in a baseband or as part of a carrier wave with computer readable program code embodied thereon. Such broadcasted data signal may be in variety of forms, including but not limited to an electromagnetic signal, an optical signal, or any suitable combination of the foregoing. The computer readable signal medium may be any computer readable medium other than the computer readable storage medium. The computer readable signal medium may send, broadcast, or transmit the program for use by or in connection with the instruction execution system, apparatus, or device. The program code embodied on the computer readable medium may be transmitted by any suitable medium including, but not limited to, an electrical wire, an optical fiber cable, RF (radio frequency), or any suitable combination of the foregoing.

In some implementations, clients and servers may communicate using any currently known or future developed network protocol such as HyperText Transfer Protocol (HTTP), and may interconnect with any form or medium of digital data communication (such as communication networks). Examples of communication networks include a local area network (“LAN”), a wide area network (“WAN”), an internet (such as the Internet), and an end-to-end network (such as ad hoc end-to-end network), as well as any currently known or future developed networks.

The computer readable medium mentioned above may be included in the electronic device mentioned above. It may also exist separately without being assembled into the electronic device.

The computer readable medium mentioned above carries one or more programs, and when one or more programs are executed by the electronic device, the electronic device implements the aforementioned method of the present disclosure.

The computer program code for carrying out operations of the present disclosure may be written in one or more programming languages, or a combination thereof. The programming languages include object-oriented programming languages, such as Java, Smalltalk, C++, and conventional procedural programming languages, such as the “C” language or similar programming languages. The program code may be executed entirely on a user computer, partly on a user computer, as a stand-alone software package, partly on a user computer and partly on a remote computer, or entirely on a remote computer or server. In the case of a remote computer, the remote computer may be connected to the user computer through any kind of network, including a local area network (LAN) or a wide area network (WAN). Alternatively, the remote computer may be connected to an external computer (e.g., over the Internet provided by the Internet service provider).

The flowcharts and block diagrams in the drawings illustrate the architecture, functionality, and operation of possible implementations of the system, the method and the computer program product according to various embodiments of the present disclosure. In this regard, each block in the flowcharts or block diagrams may represent a module, a program segment, or a portion of code. The module, program segment, or portion of code contains one or more executable instructions for implementing specified logical functions. It should also be noted that, in some alternative implementations, the functions illustrated in the blocks may be implemented in an order different from the order illustrated in the drawings. For example, two blocks shown in succession may, in fact, be implemented substantially concurrently, or in a reverse order, depending on the functionality involved. It should further be noted that each block in the block diagrams and/or flowcharts and a combination of blocks in the block diagrams and/or flowcharts may be implemented in special purpose hardware-based system that performs the specified functions or operations, or may be implemented in a combination of special purpose hardware and computer instructions.

The units involved in the embodiments of the present disclosure may be implemented by software or hardware. The name of a unit does not, in any case, qualify the unit itself.

The functions described herein above may be executed, at least partially, by one or more hardware logic components. For example, without limitation, available exemplary types of hardware logic components include: a Field Programmable Gate Array (FPGA), an Application Specific Integrated Circuit (ASIC), an Application Specific Standard Product (ASSP), a System on Chip (SOC), a Complex Programmable Logical Device (CPLD), etc.

In the context of the present disclosure, a machine-readable medium may be a tangible medium, which may contain or store a program used by the instruction execution system, apparatus, or device or a program used in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any proper combination thereof. The machine-readable storage media, for example, includes an electrical connection based on one or more wires, a portable computer disk, a hard drive, a random access memory (RAM), a read only memory (ROM), an erasable programmable read-only memory (EPROM or flash memory), an optical fiber, a portable compact disk read only memory (CD-ROM), an optical storage device, a magnetic storage device, or any proper combination thereof.

According to one or more embodiments of the present disclosure, a method of display control is provided. The method comprises:
displaying, in a display area of a target application, at least part of pages opened in the target application, if a number of pages opened in the target application exceeds n, displaying n opened pages in the display area of the target application and hiding other pages, and displaying a page identifier of a hidden page, n being not less than 1; and
in response to a triggering operation on the page identifier, displaying a page corresponding to the triggered page identifier in the display area of the target application.

According to one or more embodiments of the present disclosure, a method of display control is provided. The n opened pages displayed in the display area are horizontally arranged for display. The page identifier of the hidden page is vertically arranged on a left sidebar side or a right sidebar side of the display area.

According to one or more embodiments of the present disclosure, a method of display control is provided. The target application is an instant messaging application; or, the target application is an application suite that integrates an instant messaging application and at least one further application.

According to one or more embodiments of the present disclosure, a method of display control is provided, and the pages opened in the target application comprises a session window.

According to one or more embodiments of the present disclosure, a method of display control is provided. The pages opened in the target application comprise a session window of a first session and a further page. The further page is a page opened directly or indirectly based on the session window of the first session.

According to one or more embodiments of the present disclosure, a method of display control is provided, and the method further comprises: in response to switching from the first session to a second session, closing the session window of the first session and the further page that are opened before switching to the second session.

According to one or more embodiments of the present disclosure, a method of display control is provided, wherein n is not less than 2, and the target application has an information flow window located in the display area; if n pages are displayed in a display area of a communication client, hiding the information flow window; if a number of pages displayed in the display area is less than n, displaying the information flow window.

According to one or more embodiments of the present disclosure, a method of display control is provided, wherein displaying, in a display area of a target application, at least part of pages opened in the target application comprises:
displaying a session window in the display area, in response to an operation on a link element in the session window, opening a target page referenced by the link element in a page container at a same level as the session window.

According to one or more embodiments of the present disclosure, a method of display control is provided, wherein displaying, in a display area of a target application, at least part of pages opened in the target application comprises:
displaying, in the display area, an information flow window and a session window; and
in response to an operation on a link element in the session window, opening a target page referenced by the link element in a page container at a same level as the session window, displaying the session window and the target page referenced by the link element in the display area, and hiding the information flow window.

According to one or more embodiments of the present disclosure, a display control method is provided, wherein in response to an operation on a link element in the session window, opening a target page referenced by the link element in a page container at a same level as the session window comprises:
in response to an operation on the link element in the session window, intercepting an event of opening the target page;
deciding whether the target page meets a condition of opening in the page container;
if the condition is satisfied, adding a new page container and opening the target page in the newly added page container;
if the condition is unsatisfied, opening the target page in a browser.

According to one or more embodiments of the present disclosure, a method of display control is provided, wherein the page container is a container implemented by an inline frame element.

According to one or more embodiments of the present disclosure, a method of display control is provided. The method further comprises:
if n pages are displayed in the display area, in response to opening a new page in the target application, displaying n pages comprising the new page in the display area, hiding one of the n pages displayed before opening the new page, and displaying a page identifier corresponding to the hidden page.

According to one or more embodiments of the present disclosure, a method of display control is provided, wherein at least one of the following is satisfied:
a newly opened page in the target application locates on a first side of an opened page;
if a second new page is opened by performing an operation on a first opened page, the second page is displayed at a location adjacent to a first side of the first page on which the operation is performed.

According to one or more embodiments of the present disclosure, a method of display control is provided, wherein n is not less than 2, and if the second new page is opened by performing an operation on the first opened page, displaying the first page and the second page in the display area; and/or
n is not less than 2, before performing an operation on the first opened page, n pages are displayed in the display area; if the first page is not a page closest to a first side in the display area, closing the page closest to the first side in the display area while opening the second page, and if the first page is the page closest to the first side in the display area, hiding a page closest to a second side in the display area, the second side and the first side being two opposite sides.

According to one or more embodiments of the present disclosure, a method of display control is provided. The method further comprises at least one of:
a newly opened page in the target application displaying on a first side of an opened page, upon the page identifier being triggered, closing a page located on the first side of a page corresponding to the triggered page identifier;
in response to a page displayed in the display area moving out of the display area in a direction towards the first side of the display area, closing the page moved outside the display area;
in response to closing a page currently displayed in the display area, displaying a page from the hidden pages that is adjacent to a location of the currently displayed page.

According to one or more embodiments of the present disclosure, a method of display control is provided. The method further comprises at least one of:
in response to a number of pages opened in the target application reaches m, opening a newly opened page by a browser, m being greater than n;
the page having a first control for opening the page in a browser;
in response to the opened page being a document page, hiding at least one of document notification, comment area, or directory area by default;
in response to a control identifier hovering over the page identifier, displaying page information of a page corresponding to the page identifier;
in response to a moving operation on the page identifier, adjusting a display location of the page identifier.

According to one or more embodiments of the present disclosure, an apparatus for display control is provided. The apparatus comprises:
a displaying module configured to display, in a display area of a target application, at least part of pages opened in the target application, if a number of pages opened in the target application exceeds n, display n opened pages in the display area of the target application and hide other pages, and display a page identifier of a hidden page, n being not less than 1; and
a controlling module configured to, in response to a triggering operation on the page identifier, display a page corresponding to the triggered page identifier in the display area of the target application.

According to one or more embodiments of the present disclosure, a terminal is provided. The terminal comprises: at least one memory and at least one processor, wherein the at least one memory is configured to store program code, and the at least one processor is configured to call the program code stored in the at least one memory to implement any of the methods described above.

According to one or more embodiments of the present disclosure, a computer readable storage medium is provided, wherein the computer readable storage medium is configured to store program code, and the program code, when executed by a computer, causes the computer to implement any of the methods described above.

The above description illustrates merely preferred embodiments of the present disclosure and the technical principles employed in the present disclosure. Those skilled in the art should understand that the scope of disclosure involved in the present disclosure should cover other technical solutions formed by any combination of the above technical features or their equivalents without departing from the above disclosed concept, for example, a technical solution formed by replacing the feature with (but not limited to) a technical feature with similar functions disclosed herein, rather than be limited to the technical solutions formed by the specific combination of the technical features.

In addition, although the above operations are described in a specific order, it should not be understood that these operations are required to be performed in the specific order or performed in a sequential order. In some conditions, multitasking and parallel processing may be advantageous. Although multiple implementation details are included in the above descriptions, the details should not be interpreted as limitations to the scope of the present disclosure. Some features described in an embodiment may be implemented in combination in another embodiment. In addition, the features described in an embodiment may be implemented individually or in any suitable sub-combination form in multiple embodiments.

Although the subject of the present disclosure has been described according to the structural features and/or logical actions of the method, it should be understood that the subject defined in the claims is not necessarily limited to the features or actions described above. The specific features and actions described above are only examples of the implementation of the claims.

What is claimed is:

1. A method of display control, comprising:
displaying, in a display area of a target application, at least part of pages opened in the target application, if a number of pages opened in the target application exceeds n, displaying n opened pages in the display area of the target application and hiding other pages, and displaying a page identifier of a hidden page, n being not less than 1; and
in response to a triggering operation on the page identifier, displaying a page corresponding to the triggered page identifier in the display area of the target application.

2. The method of claim 1, wherein
the n opened pages displayed in the display area are horizontally arranged for display;
the page identifier of the hidden page is vertically arranged on a left sidebar side or a right sidebar side of the display area.

3. The method of claim 1, wherein
the target application is an instant messaging application; or, the target application is an application suite that integrates an instant messaging application and at least one further application.

4. The method of claim 3, wherein
the pages opened in the target application comprises a session window.

5. The method of claim 3, wherein the pages opened in the target application comprise a session window of a first session and a further page;
the further page is a page opened directly or indirectly based on the session window of the first session.

6. The method of claim 5, further comprising:
in response to switching from the first session to a second session, closing the session window of the first session and the further page that are opened before switching to the second session.

7. The method of claim 3, wherein
n is not less than 2, and the target application has an information flow window located in the display area; if n pages are displayed in a display area of a communication client, hiding the information flow window; if a number of pages displayed in the display area is less than n, displaying the information flow window.

8. The method of claim 3, wherein displaying, in a display area of a target application, at least part of pages opened in the target application comprises:
displaying a session window in the display area, in response to an operation on a link element in the session window, opening a target page referenced by the link element in a page container at a same level as the session window.

9. The method of claim 8, wherein displaying, in a display area of a target application, at least part of pages opened in the target application comprises:
displaying, in the display area, an information flow window and a session window; and
in response to an operation on a link element in the session window, opening a target page referenced by the link element in a page container at a same level as the session window, displaying the session window and the target page referenced by the link element in the display area, and hiding the information flow window.

10. The method of claim 7, wherein in response to an operation on a link element in the session window, opening a target page referenced by the link element in a page container at a same level as the session window comprises:
in response to an operation on the link element in the session window, intercepting an event of opening the target page;
deciding whether the target page meets a condition of opening in the page container;
if the condition is satisfied, adding a new page container and opening the target page in the newly added page container;
if the condition is unsatisfied, opening the target page in a browser.

11. The method of claim 7, wherein
the page container is a container implemented by an inline frame element.

12. The method of claim 1, further comprising:
if n pages are displayed in the display area, in response to opening a new page in the target application, displaying n pages comprising the new page in the display area, hiding one of the n pages displayed before opening the new page, and displaying a page identifier corresponding to the hidden page.

13. The method of claim 1, wherein at least one of the following is satisfied:
a newly opened page in the target application locates on a first side of an opened page;
if a second new page is opened by performing an operation on a first opened page, the second page is displayed at a location adjacent to a first side of the first page on which the operation is performed.

14. The method of claim 13, wherein
n is not less than 2, and if the second new page is opened by performing an operation on the first opened page, displaying the first page and the second page in the display area; and/or
n is not less than 2, before performing an operation on the first opened page, n pages are displayed in the display area; if the first page is not a page closest to a first side in the display area, closing the page closest to the first side in the display area while opening the second page, and if the first page is the page closest to the first side in the display area, hiding a page closest to a second side in the display area, the second side and the first side being two opposite sides.

15. The method of claim 1, further comprising at least one of:
a newly opened page in the target application displaying on a first side of an opened page, upon the page identifier being triggered, closing a page located on the first side of a page corresponding to the triggered page identifier;
in response to a page displayed in the display area moving out of the display area in a direction towards the first side of the display area, closing the page moved outside the display area;
in response to closing a page currently displayed in the display area, displaying a page from the hidden pages that is adjacent to a location of the currently displayed page.

16. The method of claim 1, further comprising at least one of:
in response to a number of pages opened in the target application reaches m, opening a newly opened page by a browser, m being greater than n;
the page having a first control for opening the page in a browser;
in response to the opened page being a document page, hiding at least one of document notification, comment area, or directory area by default;
in response to a control identifier hovering over the page identifier, displaying page information of a page corresponding to the page identifier;
in response to a moving operation on the page identifier, adjusting a display location of the page identifier.

17. A terminal, comprising:
at least one memory and at least one processor,
wherein the at least one memory is configured to store program code, and the at least one processor is configured to call the program code stored in the at least one memory to perform acts comprising:
displaying, in a display area of a target application, at least part of pages opened in the target application, if a number of pages opened in the target application exceeds n, displaying n opened pages in the display area of the target application and hiding other pages, and displaying a page identifier of a hidden page, n being not less than 1; and
in response to a triggering operation on the page identifier, displaying a page corresponding to the triggered page identifier in the display area of the target application.

18. The terminal of claim 17, wherein
the n opened pages displayed in the display area are horizontally arranged for display;
the page identifier of the hidden page is vertically arranged on a left sidebar side or a right sidebar side of the display area.

19. The terminal of claim 17, wherein
the target application is an instant messaging application; or, the target application is an application suite that integrates an instant messaging application and at least one further application.

20. A non-transitory computer readable storage medium, wherein the computer readable storage medium is configured to store program code, and the program code, when executed by a computer, causes the computer to perform acts comprising:
displaying, in a display area of a target application, at least part of pages opened in the target application, if a number of pages opened in the target application exceeds n, displaying n opened pages in the display area of the target application and hiding other pages, and displaying a page identifier of a hidden page, n being not less than 1; and
in response to a triggering operation on the page identifier, displaying a page corresponding to the triggered page identifier in the display area of the target application.
